(19) United States
(12) Patent Application Publication
(10) Pub. No.: US 2025/0307971 A1
(43) Pub. Date: Oct. 2, 2025

(54) TECHNIQUES FOR GENERATING CUSTOMIZED EVENT MEDIA TO FACILITATE EVENT ENGAGEMENT

(71) Applicant: Adeia Guides Inc., San Jose, CA (US)

(72) Inventor: Mathew Adams, Matthews, NC (US)

(21) Appl. No.: 18/618,041

(22) Filed: Mar. 27, 2024

(51) Int. Cl. G06Q 50/34; G07F 17/32

(52) U.S. Cl. CPC G06Q 50/34; G07F 17/3288

(57) ABSTRACT

Systems and methods are provided herein for providing on-demand sports betting by generating sports media content using historical sport outcomes. This may be accomplished by a simulation engine simulating a plurality of games using historical sports data. The simulation engine modifies the historical sports data based on the simulated results of the plurality of games to generate balanced sports data. A scenario engine may then simulate a plurality of events using the balanced sports data. The scenario engine selects a subset of the plurality of events based on the simulated outcomes of the plurality of events. The scenario engine also generates betting information related to the selected subset of the plurality of events. The betting information is used to generate a user interface comprising personalized betting options and simulated sports media content related to the personalized betting options.

### BACKGROUND

The present disclosure relates to the generation of media, and in particular to techniques for generating customized media to encourage event engagement.

### SUMMARY

Sports betting is an increasingly popular pastime and an activity that enhances many users' sports media consumption experience. However, a major inconvenience related to sports betting relates to both the inflexible scheduling of sporting events and the limited amount of sporting events that may be of interest to a user. For example, many professional sports (e.g., football, baseball, basketball, etc.) have off-seasons where no games are played. During the off-seasons, users are unable to watch their favorite teams participate in games and are also unable to participate in sports betting relating to said games. The problem related to the limited number of sporting events that may be of interest to a user continues even after a sport's season starts. For example, many professional sports teams only play one or two games a week. During the time between games, users are unable to watch their favorite teams participate in games and are also unable to participate in sports betting relating to their favorite team. Further, some users may have events (e.g., work, doctor's appointments, family gatherings, etc.) scheduled during the time of a sporting event that they would like to watch. Due to the inflexible scheduling of said sporting events, users may be unable to view the games diminishing the sports media viewing experience and/or the sports betting experience. In view of these deficiencies, there exists a need for the generation of more sports media content so a user can more easily consume and bet on sports media related to their interests (e.g., favorite sports, favorite teams, favorite players, etc.).

Accordingly, techniques are disclosed herein for providing on-demand sports betting by generating personalized sports media content using historical sport outcomes. To generate personalized sports media for on-demand sports betting, a system may receive historical sports data from one or more sources. The historical sports data may comprise ratings and attributes related to sports teams and/or individual players. For example, the historical sports data may comprise information related to a team's record, tendencies, roster, etc., and/or for individual player's speed, strength, height, weight, wingspan, health, etc. The system may utilize a simulation engine that simulates sports games using the historical sports data. The simulation engine may then modify the historical sports data to ensure that the results of the simulated games match the historical outcomes. For example, the simulation engine may simulate the entire 1993 National Football League season using the historical sports data. The simulation engine may determine that the Green Bay Packer's simulated record is 5 wins and 11 losses, but the Green Bay Packer's historical record is 9 wins and 7 losses. Accordingly, the simulation engine may modify the historical sports data to generate modified historical sports data and then simulate the entire 1993 National Football League season again. The simulation engine may repeat this process until the results of the simulated games match the historical outcomes. The simulation engine may continue to refine and balance the data depending on the desired granularity. For example, the simulation engine may modify the historical sports data until the simulated win/loss records of each football team in the simulated 1993 season match the historical win/loss records. In another example, the simulation engine may modify the historical sports data until the simulated win/loss records of each football team in the simulated 1993 season match the historical win/loss records, and the simulated score of each simulated game of the simulated 1993 season match the historical scores from the historical 1993 season.

The scenario engine may then use the modified historical sports data and/or the simulations generated by the simulation engine to identify betting scenarios. Scenarios may refer to any event where a user can predict an outcome, which may include placing a bet. For example, scenarios may include betting on a team victory, a team loss, a team scoring a point, a team being successful on a play, a team being unsuccessful on a play, a player scoring a point, a player being successful on a play, a player being unsuccessful on a play, and/or similar such events. The scenario engine may identify candidate betting scenarios based on the percentages associated with certain outcomes of scenarios. For example, scenarios with unfavorable odds (e.g., something that occurs 99% of the time, something that happens 1% of the time) may be discarded while scenarios with more favorable odds (e.g., something occurs 40% of the time) may be identified. A video simulation engine may receive the identified betting scenarios and generate sports media content based on the identified betting scenarios. In some embodiments, the video simulation engine may use a game engine and/or generative artificial intelligence (AI) to generate a piece of media content depicting a betting scenario. For example, a first betting scenario may be whether the Dallas Cowboys will score a touchdown when they are in the redzone. The video simulation engine may generate a first piece of media content depicting the Dallas Cowboys scoring the touchdown, and may generate a second piece of media content depicting the Dallas Cowboys not scoring the touchdown. In some embodiments, the video simulation engine uses historical media to generate one or more pieces of media content depicting a betting scenario. For example, the video simulation engine may edit a recorded video depicting the Dallas Cowboys scoring a touchdown to generate the first piece of media content.

A device (e.g., smartphone, tablet, desktop, kiosk, etc.) may display a user interface using betting information. The betting information may include the identified betting scenarios, metadata related to the betting scenarios, media content related to the betting scenarios, and/or similar such information. The device may display the user interface in response to one or more user inputs. For example, the device may display a menu comprising a plurality of icons corresponding to betting options. A first selectable icon may be associated with the Dallas Cowboys scoring a touchdown, and a second selectable icon may be associated with the Green Bay Packers losing a game. In response to the user selecting the first icon the device may display the user interface. The user interface may comprise one or more options. For example, a first option may correspond to a bet that the Dallas Cowboys will score a touchdown and a second option may correspond to a bet that the Dallas Cowboys will not score a touchdown. In some embodiments, the user interface also displays the percentages or odds related to the one or more options. For example, the user interface may display that the first option is associated with a 40% chance of success and the second option is associated with a 60% chance of success.

In response to the user's selection, the device may run the simulation and determine whether the user won or lost the bet. If the user won the bet, then the device may display an updated user interface comprising a first graphic indicating that the bet was successful. If the user lost the bet, then the updated user interface may comprise a second graphic indicating that the bet was unsuccessful. In addition to the graphic indicating the outcome of the bet, the updated user interface also displays one or more pieces of media content depicting the betting scenario. For example, if the user won the bet, then the updated user interface may display the first piece of media content, generated by the video simulation engine, depicting the Dallas Cowboys scoring the touchdown and if the user lost the bet, then the updated user interface may display the second piece of media content, generated by the video simulation engine, depicting the Dallas Cowboys not scoring the touchdown.

In some embodiments, the device recommends betting scenarios to a user based on user preferences. For example, the device may receive a profile associated with the user, where the profile comprises at least one user preference (e.g., the user likes or follows the Dallas Cowboys). The device may then recommend scenarios related to the Dallas Cowboys to the user based on the user's preferences. The scenario engine may also use viewing trends when identifying betting scenarios. For example, the historical sports data may indicate team popularity, athlete popularity, highlight moments, etc., and the scenario engine may use such information to select betting scenarios.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative flowchart of a process for generating customized sports media assets using historical sport outcomes, in accordance with some embodiments of this disclosure.

FIGS. 2A-2D show illustrative diagrams of a user interface for providing customized sports media assets, in accordance with some embodiments of this disclosure.

FIG. 3 shows an illustrative block diagram of a media system, in accordance with embodiments of the disclosure.

FIG. 4 shows another illustrative block diagram of a media system, in accordance with embodiments of the disclosure.

FIG. 5 shows an illustrative block diagram of a user equipment device system, in accordance with some embodiments of the disclosure.

FIG. 6 shows an illustrative block diagram of a server system, in accordance with some embodiments of the disclosure.

FIG. 7 is an illustrative flowchart of a process for generating customized sports media assets using historical sport outcomes, in accordance with some embodiments of this disclosure.

FIG. 8 is an illustrative flowchart of a process for generating balanced sports data, in accordance with some embodiments of this disclosure.

FIG. 9 is an illustrative flowchart of a process for generating betting information, in accordance with some embodiments of this disclosure.

### DETAILED DESCRIPTION

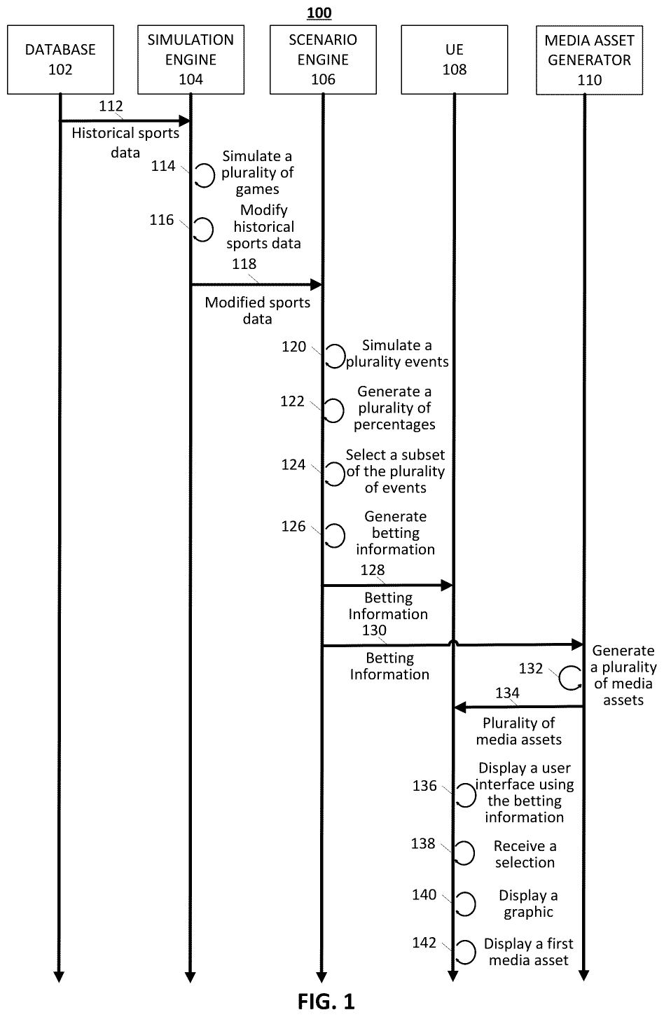

FIG. 1 shows an illustrative flowchart of a process 100 for generating customized sports media assets using historical sport outcomes in accordance with some embodiments of the disclosure. In some embodiments, some steps of process 100 may be performed by one of several devices. Although a database 102, a simulation engine 104, a scenario engine 106, a user equipment (UE) 108, and a media asset generator 110 are shown any number of devices may be used. In some embodiments, one or more devices are combined. For example, a single server may comprise the simulation engine 104, the scenario engine 106, and/or the media asset generator 110. Although the process 100 is illustrated and described as a sequence of steps, it is contemplated that various embodiments of process 100 may be performed in any order or combination and need not include all the illustrated steps.

At step 112, the database 102 may transmit historical sports data to the simulation engine 104. In some embodiments, the historical sports data may comprise ratings and attributes related to sports teams and/or individual players. For example, the historical sports data may comprise information related to a team's record, tendencies, roster, etc., and/or for individual player's speed, strength, height, weight, wingspan, health, etc. In some embodiments, the historical sports data may also comprise historical media (e.g., audio/video of historical games, promotional material related to historical games, images related to historical games, etc.). In some embodiments, the database 102 transmits the historical sports data in response to one or more requests. For example, the simulation engine 104 may transmit a request to the database 102 for historical sports data. In some embodiments, the request may include metadata specifying a type of historical sports data. For example, the metadata may indicate a particular sport (e.g., football) and the database 102 may transmit historical sports data related to the identified sport. In another example, the metadata may indicate a particular sport (e.g., football), league (e.g., National Football League), and season (e.g., season of 1993), and the database 102 may transmit historical sports data related to the identified sport, league, and season. In some embodiments, the database 102 may transmit historical sports data according to any level of granularity. Although one database is shown for simplicity, any number of databases may be used. In some embodiments, different databases comprise different historical sports data. For example, a first database may comprise historical sports data related to football while a second database may comprise historical sports data related to basketball. In another example, a first database may comprise historical sports data related to professional football while a second database may comprise historical sports data related to college football. Although many embodiments are described in relation to sports, any non-sport event may also be simulated. For example, the process 100 may use historical event data about spelling bees, political races, weather patterns, and/or similar such events in the same or similar manner as historical sports data.

At step 114, the simulation engine 104 simulates a plurality of games using the historical sports data. At step 116, the simulation engine 104 may modify the historical sports data based on the plurality of simulated games. In some embodiments, the simulation engine 104 modifies the historical sports data to help direct the results of the simulated games to be within a threshold discrepancy or range of historical outcomes. For example, the simulation engine 104 may simulate the entire 1993 National Football League season using the historical sports data. The simulation engine 104 may determine that the Green Bay Packer's simulated record was 5 wins and 11 losses, but the Green Bay Packer's historical record was 9 wins and 7 losses. The threshold discrepancy may be plus or minus one game of the historical record, for instance. Accordingly, the simulation engine 104 may modify the historical sports data because the simulated record (e.g., 5 wins and 11 losses) is not within the threshold discrepancy (e.g., plus or minus one game) of the historical record (e.g., 9 wins and 7 losses). In some embodiments, the simulation engine 104 modifies the historical sports data according to the difference between the simulated record and the historical record. For example, because the simulated record (e.g., 5 wins and 11 losses) was less than the historical record (e.g., 9 wins and 7 losses), the simulation engine 104 may increase one or more portions or aspects of the historical sports data. In some embodiments, increasing one or more portions of the historical sports data includes increasing one or more values associated with the historical sports data. For example, the simulation engine 104 may increase one or more values associated with the offense, defense, special teams, quarterback, running back, etc. associated with the Green Bay Packers. In some embodiments, increasing one or more portions of the historical sports data comprises adjusting one or more weights associated with the historical sports data. For example, the simulation engine 104 may increase one or more weights associated with the offense, defense, special teams, quarterback, running back, etc., associated with the Green Bay Packers.

In some embodiments, the simulation engine 104 selects which portions of the historical sports data are more deterministic of a target result and creates data structures to link particular sets of the portions of the historical sports data with the target result. For example, the simulated record for the Green Bay Packers may be less determined by the individual weight, height, speed of players on the Green Bay Packers and may be more determined based on the health/availability of players and their game play statistics (e.g., rushing yard average, completion percentage, receiving touchdowns, turnover ratio, etc.). However, the simulated outcome of Green Bay Packers scoring a touchdown from the 5-yard-line may be more influenced by the individual weight, height, speed of players on the Green Bay Packers. Storing correlations between portions of historical sports data and sports outcomes allows for more efficient and reliable creation of hypothetical on-demand betting scenarios based on user selection.

The simulation engine 104 may repeat steps 114 and 116 until the results of the simulated games are within the threshold discrepancy of the historical outcomes. For example, the simulation engine 104 may simulate the entire 1993 National Football League season again using the modified sports data. The simulation engine 104 may then compare the updated results of the simulated games to the historical outcomes. The simulation engine 104 may continue to refine and balance the data depending on one or more thresholds and/or one or more desired granularities. For example, the simulation engine 104 may continue to modify the historical sports data until the simulated win/loss records of each football team in the simulated 1993 season are within a threshold of the historical win/loss records. In another example, the simulation engine 104 may modify the historical sports data until the simulated win/loss records of each football team in the simulated 1993 season are within a first threshold (e.g., plus or minus one game) of the historical win/loss records and the simulated score of each simulated game of the simulated 1993 season is within a second threshold (e.g., plus or minus three points) of the historical scores from the historical 1993 season. In some embodiments, process 100 provides for the simulation of hypothetical or fantasy scenarios. Further, the process provides that the outcomes of the hypothetical or fantasy scenarios to be more historically accurate and more engaging.

In some embodiments, the simulation engine 104 refines and balances the data according to the one or more thresholds and/or one or more desired granularities based on the simulated results. For example, simulation engine 104 may simulate the entire 1993 National Football League season again using the modified historical sports data and determine that the new simulated record is the same as the historical record (e.g., 9 wins and 7 losses). However, the simulation engine 104 may determine whether the simulated scores of each game of the simulated season are within a second threshold (e.g., within 10 points) of the historical scores. If the simulated scores of each game of the simulated season are not within the second threshold (e.g., within 10 points) then the simulation engine 104 may repeat steps 114 and 116 until the scores of the simulated games are within the second threshold (e.g., within 10 points) of the historical scores. In some embodiments, the simulation engine 104 analyzes the difference between the historical results and the simulated results when modifying the historical sports data. For example, the simulation engine 104 may modify more portions of the historical sports data and/or more heavily modify the historical sports data if the simulated results are further from the historical results and the simulation engine 104 may modify fewer portions of the historical sports data and/or modify less of the historical sports data if the simulated results are closer to the historical results.

At step 118, the simulation engine 104 transmits the modified sports data to the scenario engine 106. In some embodiments, one or more devices (e.g., the simulation engine 104, the scenario engine 106, etc.) use the same or similar processing methods (e.g., AI model, machine learning (ML) model, etc.) when processing the modified sports data to ensure consistent simulated results from the same data. At step 120, the scenario engine 106 simulates a plurality of events using the modified sports data. In some embodiments, the plurality of events correspond to betting scenarios (e.g., a team victory, a team loss, a team scoring a point, team being successful/unsuccessful on a play, a player scoring a point, a player being successful/unsuccessful on a play, and/or similar such events).

In some embodiments, the plurality of events correspond to hypothetical or fantasy scenarios. For example, a first hypothetical scenario may correspond to the 1985 Chicago Bears playing a basketball game against the 2016 Chicago Cubs. The simulation engine 104 may utilize the modified sports data to provide a plurality of results (e.g., score of the game, which player scored the most points, which player had the most rebounds, which player had the most blocks, etc.) based on one or more portions of the modified sports data (e.g., speed, height, weight, etc.) that relates to each team. In some embodiments, one or more portions of the modified sports data related to athletes that played multiple sports are used to generate more accurate results related to hypothetical or fantasy scenarios. For example, portions of modified sports data related to Deon Sanders (an athlete that played football and baseball) may be used to extrapolate modified sports data related to a football player or football team participating in a baseball-related fantasy scenario. In some embodiments, one or more portions of the modified sports data related to athletes that played sports at different levels are used to generate more accurate results related to hypothetical or fantasy scenarios. For example, portions of modified sports data related to an athlete that played football in high school, college and the NFL may be used to extrapolate modified sports data related to a football player or football team participating against teams of different levels (e.g., the 2010 Cincinnati Bengals playing the 2010 Auburn Tigers). In some embodiments, one or more portions of the modified sports data related to athletes that played against different genders are used to generate more accurate results related to hypothetical or fantasy scenarios. For example, portions of the modified sports data related to an athlete that played against female and males may be used to extrapolate modified sports data related to players participating against players of other genders (e.g., Michael Jordan playing against Sylvia Fowles).

At step 122, the scenario engine 106 generates a plurality of percentages associated with the plurality of events. In some embodiments, the scenario engine 106 generates the plurality of percentages by simulating each event of the plurality of events multiple times (e.g., 10 times, 100 times, 1,000, times, 10,000 times etc.). For example, the scenario engine 106 may use the modified sports data to simulate a first event corresponding to the Dallas Cowboys playing the Green Bay Packers. The scenario engine 106 may simulate the first event one thousand times and determine a first percentage (e.g., 60%) corresponding to how many times the Dallas Cowboys beat the Green Bay Packers in the one thousand simulations. In some embodiments, the scenario engine 106 calculates one or more of the plurality of percentages using the modified sports data.

At step 124, the scenario engine 106 selects a subset of the plurality of events. The scenario engine 106 may select the subset of the plurality of events based on the percentages associated with each event of the subset of events. For example, the first event associated with the Dallas Cowboys playing the Green Bay Packers may be selected because the first percentage corresponding to how many times the Dallas Cowboys beat the Green Bay Packers is 60%. In some embodiments, the subset of the plurality of events are selected if the percentages associated with each event of the subset of events are within a first range (e.g., between 30% and 70%). In some embodiments, the subset of the plurality of events are selected if the percentages associated with each event of the subset of events are above a second threshold (e.g., above 15%). In some embodiments, the subset of the plurality of events are selected if the percentages associated with each event of the subset of events are below a third threshold (e.g., below 65%).

At step 126, the scenario engine 106 generates betting information. The betting information may include the subset of the plurality of events, metadata related to the subset of the plurality of events, media content related to the subset of the plurality of events, and/or similar such information. In some embodiments, the metadata related to the subset of the plurality of events includes the percentages associated with each event of the subset of events, historical sports data related to the subset of the plurality of events, modified historical sports data, and/or similar such information. In some embodiments, the media content related to the subset of the plurality of events includes historical media (e.g., audio/video of historical games, promotional material related to historical games, images related to historical games, etc.).

At step 128, the scenario engine 106 transmits betting information to the UE 108. At step 130, the scenario engine 106 transmits betting information to the media asset generator 110. In some embodiments, the scenario engine 106 transmits the same betting information to the UE 108 and the media asset generator 110. In some embodiments, the scenario engine 106 transmits different portions of the betting information to different devices. For example, the scenario engine 106 may transmits betting information comprising the subset of the plurality of events and the metadata related to the subset of the plurality of events to the UE 108 and may transmits betting information comprising the subset of the plurality of events and media content related to the subset of the plurality of events to the media asset generator 110.

At step 132, the media asset generator 110 generates a plurality of media assets. In some embodiments, each media asset of the plurality of media assets corresponds to one or more events of the subset of the plurality of events. For example, the media asset generator 110 may receive betting information comprising the subset of the plurality of events from the scenario engine 106 and then generate one or more media asset for each event of the plurality of events. In some embodiments, the media asset generator 110 generates the plurality of media assets using one or more game engines, generative AI, and/or similar such information.

In some embodiments, the media asset generator 110 generates at least one media asset for each event of the subset of the plurality of events. In some embodiments, the media asset generator 110 generates at least one media asset for each possible outcome for each event of the subset of the plurality of events. For example, a first event may be whether the Dallas Cowboys will score a touchdown when they are in the redzone. The media asset generator 110 may generate a first media asset depicting the Dallas Cowboys scoring the touchdown and may generate a second media asset depicting the Dallas Cowboys not scoring the touchdown. In some embodiments, the media asset generator 110 uses historical media to generate one or more media assets depicting one or more events. For example, if the event is a simulated game between the Dallas Cowboys and Green Bay Packers, the media asset generator 110 may select one or more historical media depicting an instance where the Dallas Cowboys played the Green Bay Packers. In another example, the media asset generator 110 may edit a recorded video depicting the Dallas Cowboys scoring a touchdown to generate a first media asset. In some embodiments, the media asset generator 110 generates one or more of the media assets with different perspectives. For example, the media asset generator 110 may generate a first media asset from the perspective of a user sitting in the Dallas Cowboy's stadium watching the Dallas Cowboys live. In another example, the media asset generator 110 may generate a second media asset from the perspective of a user watching the Dallas Cowboys on a television.

In some embodiments, the media asset generator 110 uses information received from the scenario engine 106 to generate the plurality of media assets. For example, the media asset generator 110 may receive media content related to the subset of the plurality of events from the scenario engine 106 and use the received media content related to the subset of the plurality of events to generate the plurality of media assets. In some embodiments, the media asset generator 110 uses information received from one or more databases to generate the plurality of media assets. For example, the media asset generator 110 may receive media content related to the subset of the plurality of events from one or more databases (e.g., database 102) and use the received media content related to the subset of the plurality of events to generate the plurality of media assets. In some embodiments, the media asset generator 110 uses information received from one or more databases and information received from the scenario engine 106 to generate the plurality of media assets.

In some embodiments, historical media assets matching one or more events of the plurality of events do not exist. For example, a first event may correspond to the 1985 Chicago Bears trying to score a touchdown against the 2010 Dallas Cowboys. The first event corresponds to a hypothetical event without any matching historical media assts. The media asset generator 110 may generate a media asset for the first event by combining historical media assets that are similar to the first event. For example, the media asset generator 110 may combine a first piece of historical footage of the 1985 Chicago Bears scoring a touchdown and a second piece of historical footage of the 2010 Dallas Cowboys giving up a touchdown to generate a media asset for the first event. In some embodiments, the media asset generator 110 modifies historical media assets based on the probability of success of an event. For example, a second event may correspond to the Chicago Cubs playing the Miami Marlins where Michael Jordan is playing the left field position. The media asset generator 110 may modify historical radio audio from a similar historical game (e.g., a game where the Chicago Cubs played the Miami Marlins) to generate a media asset for the second event. For example, the media asset for the second event may be audio stating “Now here's a surprise move by Dusty Baker, and I'm not sure how this is even possible, but it looks like Michael Jordan is coming in to play left field! The pitch, a fly ball out to left field, into foul territory and into the stands, no wait, Jordan comes down with the ball to record the second out of inning! The Cubs are now 4 outs from going to their first World Series since 1945!”

At step 134, the media asset generator 110 transmits the plurality of media assets to the UE 108. At step 136, the UE 108 displays a user interface using the betting information. In some embodiments, one or more portions of the user interface is generated by the media asset generator 110. In some embodiments, one or more portions of the user interface is generated by the UE 108. In some embodiments, the user interface comprises one or more options related to an event of the subset of plurality of events. For example, a first event may relate to a touchdown opportunity for the Dallas Cowboys. A first option may correspond to a bet that the Dallas Cowboys will score a touchdown and a second option may correspond to a bet that the Dallas Cowboys will not score a touchdown. In some embodiments, the user interface also displays the percentages related to the one or more options. For example, the user interface may display that the first option is associated with a 40% chance of success and the second option is associated with a 60% chance of success.

The UE 108 may display the user interface in response to one or more user inputs. For example, the UE 108 may display a menu comprising a plurality of icons corresponding to different events of the subset of the plurality of events. A first selectable icon may be associated with the Dallas Cowboys scoring a touchdown and a second selectable icon may be associated with the Green Bay Packers losing a game. In response to the user selecting the first icon the device may display the user interface. In some embodiments, the UE 108 displays the user interface based on one or more user preferences. For example, the UE 108 may have access to a profile associated with the user, wherein the profile comprises at least one user preference (e.g., the user likes the Dallas Cowboys, the user likes football, the user likes to bet on touchdown-related scenarios, etc.). The UE 108 may display a user interface related to an event associated with the Dallas Cowboys based on at least one user preference (e.g., the user likes the Dallas Cowboys, the user likes football, the user likes to bet on touchdown-related scenarios, etc.).

At step 138, the UE 108 receives a selection. For example, the user may select a first option corresponding to a bet that the Dallas Cowboys will score a touchdown. In response to the user's selection, the UE 108 may simulate the event associated with the selection. For example, the UE 108 may use the betting information's percentages to determine whether the Dallas Cowboys will score a touchdown in a first simulated event.

At step 140, the UE 108 displays a graphic. In some embodiments, the graphic corresponds to the selection made by the user and/or the outcome of the simulated event. For example, if the user won the bet, then the UE 108 may display a first graphic indicating that the bet was successful. In another example, if the user lost the bet, then the UE 108 may display a second graphic indicating that the bet was unsuccessful. In some embodiments, one or more portions of the graphic is generated by the media asset generator 110. For example, the first graphic and/or the second graphic may be part of the plurality of media assets received from the media asset generator 110. In some embodiments, one or more portions of the graphic is generated by the UE 108. The graphic may comprise text, video, audio, animation, and/or similar such content.

At step 142, the UE 108 displays a first media asset. In some embodiments, the first media asset corresponds to the outcome of the simulated event. For example, if the simulated event results in a touchdown, then the first media asset may depict the Dallas Cowboys scoring the touchdown. In another example, if the simulated event does not result in a touchdown, then the first media asset may depict the Dallas Cowboys not scoring the touchdown. In some embodiments, the first media asset is generated by the media asset generator 110. For example, the first media asset may be part of the plurality of media assets received from the media asset generator 110. In some embodiments, a subset of the plurality of media assets correspond to the event associated with the user's selection. For example, a first media asset may depict the Dallas Cowboys scoring the touchdown and a second media asset may depict the Dallas Cowboys not scoring the touchdown. In some embodiments, the UE 108 determines which media asset to display in response to the outcome of the simulated event. In some embodiments, each media asset of the subset of the plurality of media assets comprises metadata indicating that media assets relate to one or more events (e.g., first event associated with whether the Dallas Cowboys will score a touchdown).

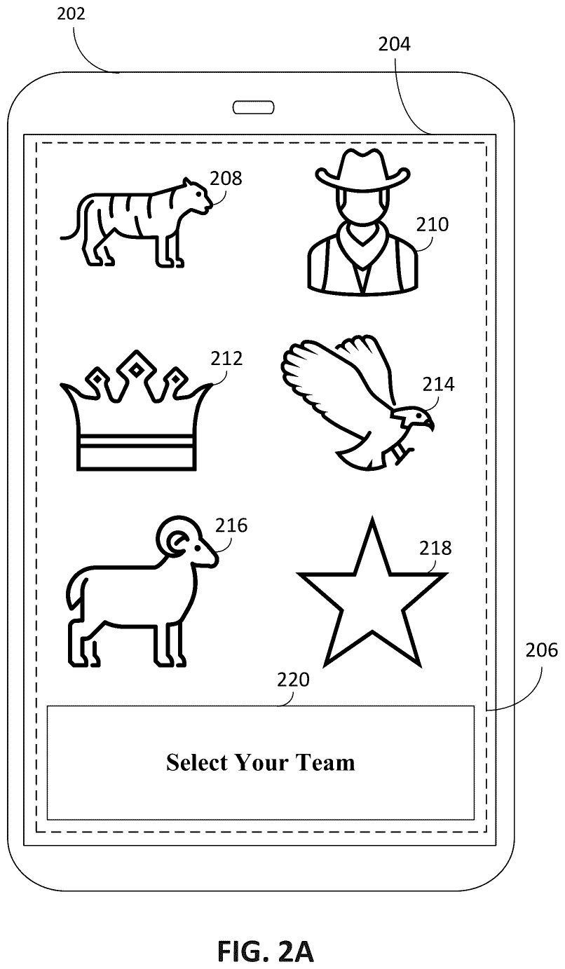

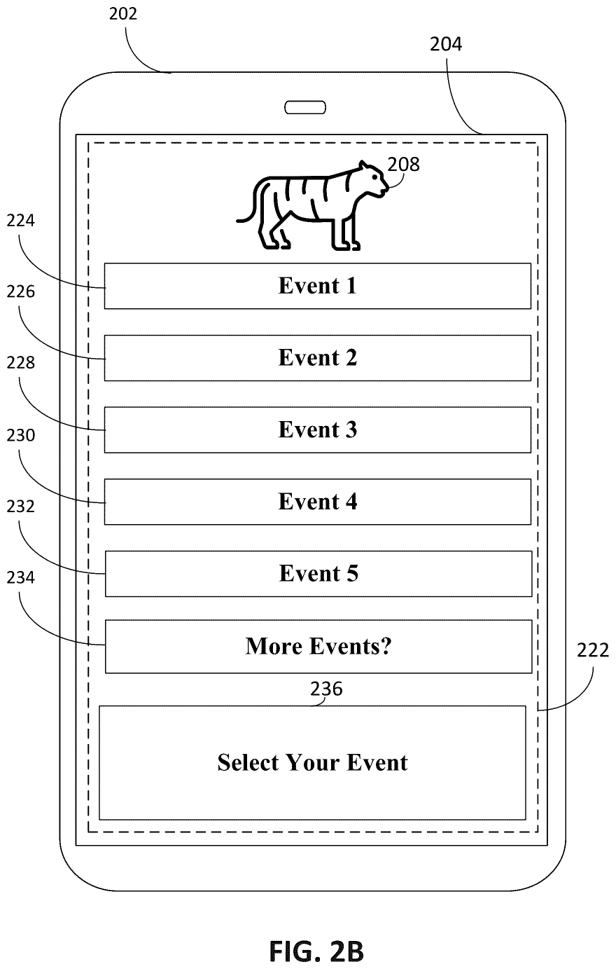

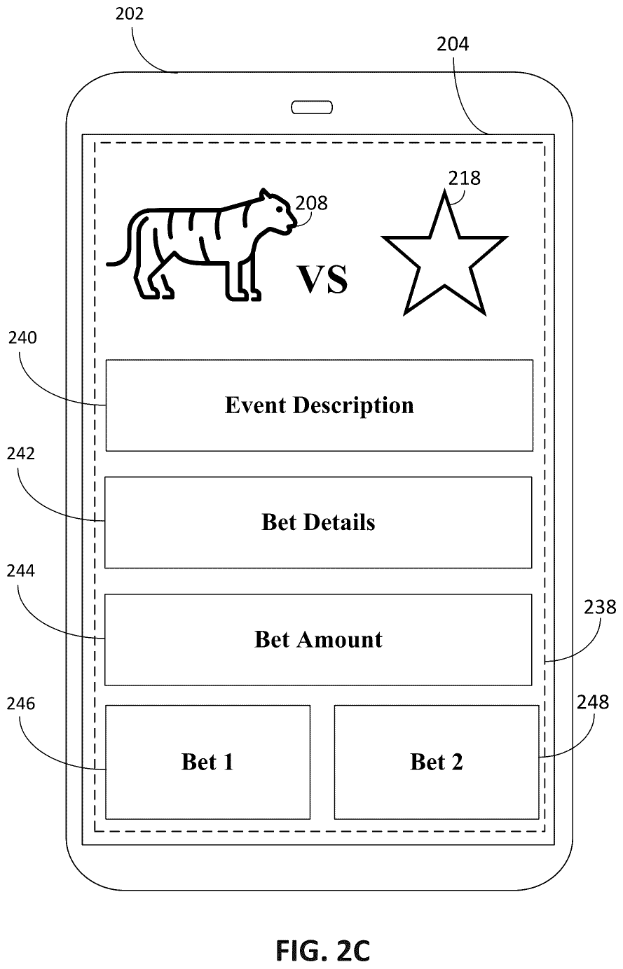

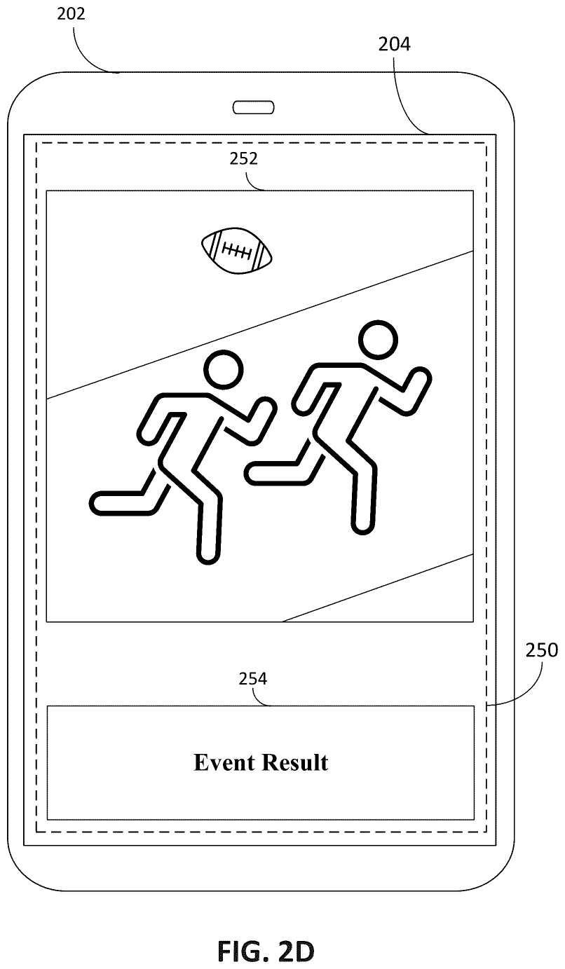

FIGS. 2A-2D show illustrative diagrams of a user interfaces for providing customized sports media assets, in accordance with some embodiments of this disclosure. The system includes a user device 202 with a display 204. The user device 202 may be a smartphone, a kiosk, a video gambling machine, a tablet, a laptop, a desktop computer, a smart watch or wearable device, smart glasses, a stereoscopic display, a wearable camera, AR glasses, an AR head-mounted display (HMD), a virtual reality (VR) HMD and/or any other device suitable for customized media display. FIG. 2A shows the display 204 displaying a first user interface 206. In some embodiments, the first user interface 206 displays a first icon 208, a second icon 210, a third icon 212, a fourth icon 214, a fifth icon 216, and a sixth icon 218. Although six icons are shown, any number of icons may be used. Further, the icons are not required to be the same size or shape. In some embodiments, each icon represents a different sports team, player, sport, timeframe, and/or similar such information. In some embodiments, the first user interface 206 also comprises a first prompt 220. The first prompt 220 may comprise one or more instructions for a user. In some embodiments, one or more icons are selectable via a user interface. For example, the display 204 may be a touch screen. In another example, a user may interact with the display 204 using a remote control, mouse, trackball, keypad, keyboard, touchpad, stylus input, joystick, and/or other user input interfaces.

FIG. 2B shows the display 204 displaying a second user interface 222. In some embodiments, the user device 202 displays the second user interface 222 in response to a user selecting one or more icons of the first user interface 206. For example, a user may select the first icon 208 of the first user interface 206. The user device 202 may then display the second user interface 222 in response to the selection of the first icon 208. In some embodiments, the second user interface 222 comprises the first icon 208 because the selection of the first icon 208 caused the user device 202 to display the second user interface 222.

In some embodiments, the second user interface 222 also displays a first option 224, a second option 226, a third option 228, a fourth option 230, a fifth option 232, and a sixth option 234. Although six options are shown, any number of options may be displayed. Further, the options are not required to be the same size or shape. In some embodiments, one or more options represent different events corresponding to the first icon 208. For example, the first icon 208 may correspond to a first team (e.g., Cincinnati Bengals), the first option 224 corresponds to a first event (e.g., 2023 Cincinnati Bengals playing the 2023 Dallas Cowboys), the second option 226 corresponds to a second event (e.g., Cincinnati Bengals trying to score a touchdown during their final drive against the 2023 Kansas City Chiefs in the AFC championship game), the third option 228 corresponds to a third event (e.g., the 1994 Cincinnati Bengals playing the 2013 Cincinnati Bengals), the fourth option 230 corresponds to a fourth event (e.g., the Cincinnati Bengals' 2019 season but with Tom Brady as the quarterback), and the fifth option 232 corresponds to a fifth event (e.g., the 2010 Cincinnati Bengals playing the 2010 Auburn Tigers). In some embodiments, the sixth option 234 results in the device 202 displaying additional options corresponding to additional events. In some embodiments, the second user interface 222 also comprises a second prompt 236. The second prompt 236 may comprise one or more instructions for a user. In some embodiments, one or more options are selectable via the user interface. For example, the display 204 may be a touch screen. In another example, a user may interact with the display 204 using a remote control, mouse, trackball, keypad, keyboard, touchpad, stylus input, joystick, and/or other user input interfaces.

FIG. 2C shows the display 204 displaying a third user interface 238. In some embodiments, the user device 202 displays the third user interface 238 in response to a user selecting one or more options of the second user interface 222. For example, a user may select the first option 224 of the second user interface 222. The user device 202 may then display the third user interface 238 in response to the selection of the first option 224. In some embodiments, the third user interface 238 comprises the first icon 208 and the sixth icon 218 because the first option 208 is related to an event associated with the first icon 208 and the sixth icon 218. For example, the first option 208 may relate to an event associated with the Cincinnati Bengals playing the Dallas Cowboys and the first icon 208 may correspond to the Cincinnati Bengals and the sixth icon 218 may correspond to the Dallas Cowboys. Although the first icon 208 and the sixth icon 218 are shown, any media related to an event associated with the third user interface 238 may be displayed. In some embodiments, the media being displayed may be one or more media assets of a plurality of media assets related to the event associated with the third user interface 238.

In some embodiments, the third user interface 238 also displays an event description 240 and betting details 242. The event description 240 may describe the event associated with the third user interface 238. For example, the event description 240 may identify the event (e.g., Cincinnati Bengals playing the Dallas Cowboys), identify additional event information (e.g., the timeframe for the event, weather associated with the event, rosters associated with the event, location of the event, etc.), and/or similar such information. The betting details 242 may describe one or more betting details related to the event. For example, the betting details 242 may identify statistics (e.g., percentages, odds, etc.) associated with one or more bets available for the event.

In some embodiments, the third user interface 238 also displays a bet amount 244, a first bet option 246, and a second bet option 248. In some embodiments, the bet amount 244 is adjustable using one or more user interfaces. For example, a user may input 5$, 50$, 500$, and/or similar such amounts. In some embodiments, the first bet option 246 and the second bet option 248 correspond to bets related to the event associated with the third user interface 238. For example, if the event is the Cincinnati Bengals playing the Dallas Cowboys, then the first bet option 246 may correspond to betting on a Cincinnati Bengals' win and the second bet option 248 may correspond to betting on a Dallas Cowboys' win. Although two betting options are shown, any number of betting options may be used. Further, the betting options are not required to be the same size or shape.

FIG. 2D shows the display 204 displaying a fourth user interface 250. In some embodiments, the user device 202 displays the fourth user interface 250 in response to a user selecting one or more betting options of the third user interface 238. For example, a user may select the first betting option 246 of the third user interface 238. The user device 202 may then display the fourth user interface 250 in response to the selection of the first betting option 246. In some embodiments, the fourth user interface 250 comprises a first media asset 252 and an event result 254. In some embodiments, the first media asset 252 and the event result 254 relate to a simulated event. For example, the user device 202 may use betting information (e.g., one or more percentages) associated with the event (e.g., Cincinnati Bengals playing the Dallas Cowboys) to simulate the event and the first media asset 252 and the event result 254 correspond to the outcome of the simulated event. If the user device 202 determines that the simulated event results in a first outcome (e.g., Cincinnati Bengals winning), then the first media asset 252 may comprise one or more pieces of media depicting the first outcome (e.g., Cincinnati Bengals scoring a winning touchdown). If the user device 202 determines that the simulated event results in a second outcome (e.g., Dallas Cowboys winning), then the first media asset 252 may comprise one or more pieces of media depicting the second outcome (e.g., Dallas Cowboys scoring a winning touchdown). In some embodiments, the first media asset 252 is generated by one or more media asset generators. In some embodiments, the first media asset 252 comprises historical media and/or simulated media.

In some embodiments, the event result 254 corresponds to the betting option selected by the user and/or the outcome of the simulated event. For example, if the user won the bet, then the event result 254 may indicate that the bet was successful. In another example, if the user lost the bet, then the event result 254 may indicate that the bet was unsuccessful. In some embodiments, one or more portions of the event result 254 is generated by one or more media asset generators. The event result 254 may comprise text, video, audio, animation, and/or similar such content.

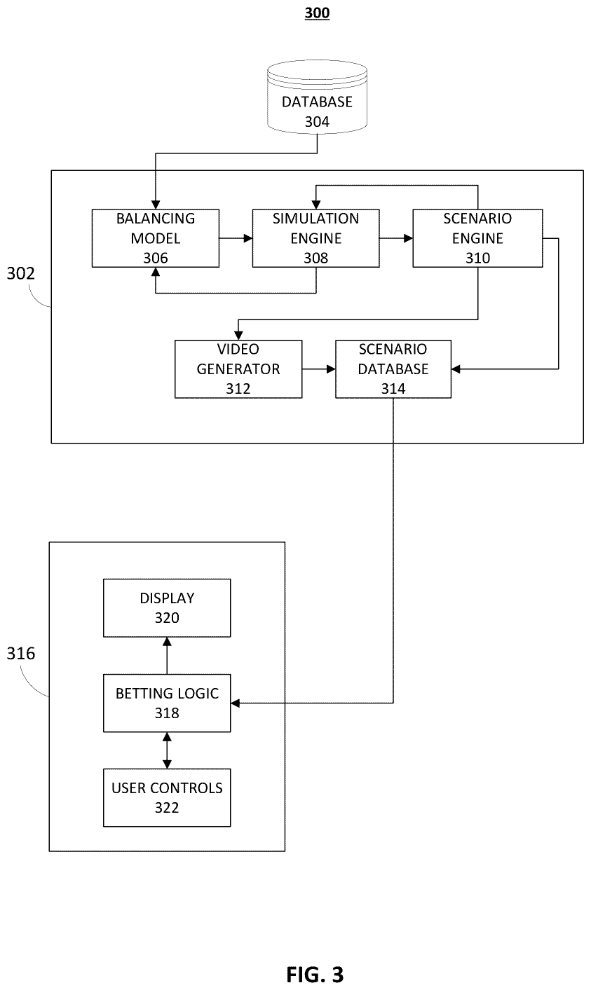

FIGS. 3-6 describe example devices, systems, servers, and related hardware for enabling the generation of customized sports media and sports betting information.

System 300 comprises a server 302 and a database 304. In the system 300, there can be more than or less than one server 302 and/or database 304, but only one are shown in FIG. 3 to avoid overcomplicating the drawing. In addition, the system 300 may utilize more than one type of server 302 and/or database 304 and more than one of each type of server 302 and/or database 304. In an embodiment, the paths shown between the server 302 and the database 304 may be communications paths, as well as other short-range point-to-point communications paths, such as USB cables, IEEE 1394 cables, wireless paths (e.g., Bluetooth, infrared, IEEE 802-11x, etc.), or other short-range communication via wired or wireless paths. In an embodiment, the server 302 and database 304 may also communicate with each other directly through an indirect path via a communications network.

The server 302 comprises a balancing model 306, a simulation engine 308, a scenario engine 310, a video generator 312, and a scenario database 314. In some embodiments, one or more of the components shown within the server 302 are distributed across multiple servers. The user equipment device 316 comprises betting logic 318, a display 320, and user controls 322. In some embodiments, one or more of the components shown within the user equipment device 316 are distributed across multiple user equipment devices and/or one or more servers. In the system 300, there can be more than or less than one user equipment devices 316, but only one is shown in FIG. 3 to avoid overcomplicating the drawing. In addition, users may utilize more than one type of user equipment device 316 and more than one of each type of user equipment device. In an embodiment, there may be paths between user equipment devices, so that the devices may communicate directly with each other via communications paths, as well as other short-range point-to-point communications paths, such as USB cables, IEEE 1394 cables, wireless paths (e.g., Bluetooth, infrared, IEEE 802-11x, etc.), or other short-range communication via wired or wireless paths. In an embodiment, the user equipment devices may also communicate with each other directly through an indirect path via a communications network.

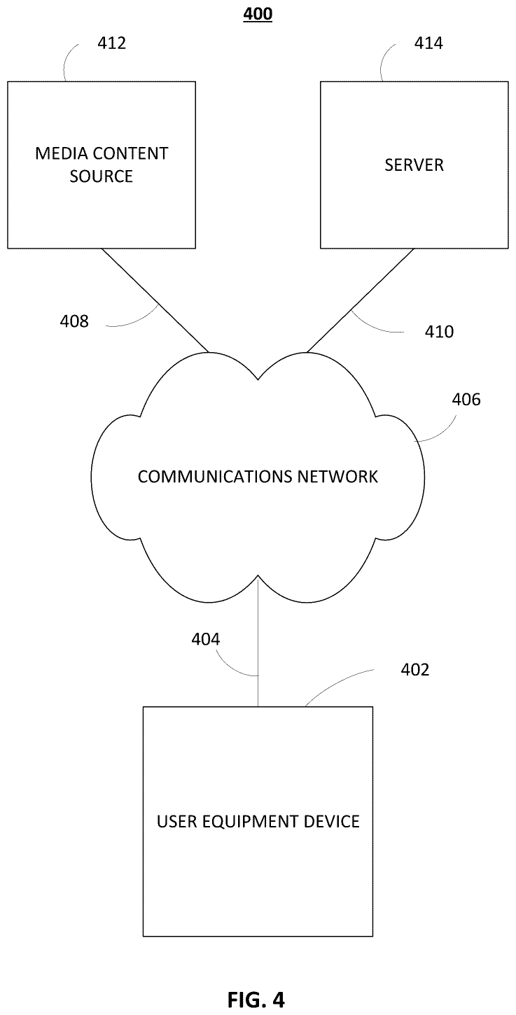

In the system 400, there can be more than or less than one user equipment devices 402, but only one is shown in FIG. 4 to avoid overcomplicating the drawing. In addition, users may utilize more than one type of user equipment device 402 and more than one of each type of user equipment device. In an embodiment, there may be paths between user equipment devices, so that the devices may communicate directly with each other via communications paths, as well as other short-range point-to-point communications paths, such as USB cables, IEEE 1394 cables, wireless paths (e.g., Bluetooth, infrared, IEEE 802-11x, etc.), or other short-range communication via wired or wireless paths. In an embodiment, the user equipment devices may also communicate with each other directly through an indirect path via the communications network 406.

The user equipment device 402, a media content source 412, and a server 414, may be coupled to communications network 406. Namely, the first user equipment device 402 is coupled to the communications network 406 via a first communications path 404, the media content source 412 is coupled to the communications network 406 via a second communications path 408, and the server 414 is coupled to the communications network 406 via a third communications path 410. The communications network 406 may be one or more networks including the Internet, a mobile phone network, mobile voice or data network (e.g., a 4G, 5G, or LTE network), cable network, public switched telephone network, or other types of communications network or combinations of communications networks. The paths may separately or in together with other paths include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. In one embodiment, the paths can be a wireless path. Communications between the devices may be provided by one or more communications paths but is shown as a single path in FIG. 4 to avoid overcomplicating the drawing.

The media content source 412 and server 414 can be coupled to any number of databases providing information to the user equipment devices. For example, media content source 412 and server 414 may have access to historical sports data, historical sports media, augmentation data, 2D mapping data, 3D mapping data, virtual object data, user information data, encryption data, and/or similar such information. The media content source 412 represents any computer-accessible source of content, such as a storage for audio content, metadata, or, similar such information. The server 414 may store and execute various software modules for enabling the generation of customized sports media and sports betting information functionality. In the system 400, there can be more than one server 414 but only one is shown in FIG. 4 to avoid overcomplicating the drawing. In addition, the system 400 may utilize more than one type of server 414 and more than one of each type of server. In some embodiments, the user equipment device 402, media content source 412, and server 414 may store metadata associated with media content.

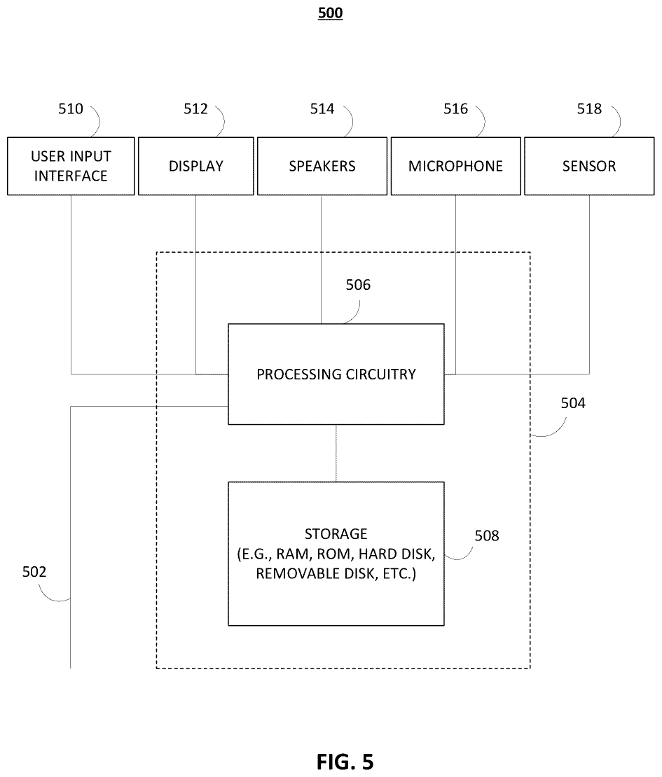

FIG. 5 shows a generalized embodiment of a user equipment device 500, in accordance with some embodiments. In some embodiments, the user equipment device 500 is an example of the user equipment devices described in FIG. 1 and FIGS. 2A-2D (e.g., UE 108, user equipment devices 102). The user equipment device 500 may receive content and data via input/output (I/O) path 502. The I/O path 502 may provide audio content (e.g., broadcast programming, on-demand programming, Internet content, content available over a local area network (LAN) or wide area network (WAN), and/or other content) and data to control circuitry 504, which includes processing circuitry 506 and a storage 508. The control circuitry 504 may be used to send and receive commands, requests, and other suitable data using the I/O path 502. The I/O path 502 may connect the control circuitry 504 (and specifically the processing circuitry 506) to one or more communications paths. I/O functions may be provided by one or more of these communications paths but are shown as a single path in FIG. 5 to avoid overcomplicating the drawing.

The control circuitry 504 may be based on any suitable processing circuitry such as the processing circuitry 506. As referred to herein, processing circuitry should be understood to mean circuitry based on one or more microprocessors, microcontrollers, digital signal processors, programmable logic devices, field-programmable gate arrays (“FPGAs”), application-specific integrated circuits (“ASICs”), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). The enabling of the generation of customized sports media and sports betting information functionality can be at least partially implemented using the control circuitry 504. The enabling of the generation of customized sports media and sports betting information functionality described herein may be implemented in or supported by any suitable software, hardware, or combination thereof. The creation and/or display of one or more user interfaces, can be implemented on user equipment, on remote servers, or across both.

In client-server-based embodiments, the control circuitry 504 may include communications circuitry suitable for communicating with one or more servers that may at least implement the described generation of customized sports media and sports betting information functionality. The instructions for carrying out the above-mentioned functionality may be stored on the one or more servers. Communications circuitry may include a cable modem, an integrated service digital network (“ISDN”) modem, a digital subscriber line (“DSL”) modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 508 that is part of the control circuitry 504. As referred to herein, the phrase “electronic storage device” or “storage device” should be understood to mean any device for storing electronic data, computer software, or firmware, such as random-access memory, read-only memory, hard drives, optical drives, digital video disc (“DVD”) recorders, compact disc (“CD”) recorders, BLU-RAY disc (“BD”) recorders, BLU-RAY 3D disc recorders, digital video recorders (“DVR”, sometimes called a personal video recorder, or “PVR”), solid-state devices, quantum storage devices, gaming consoles, gaming media, or any other suitable fixed or removable storage devices, and/or any combination of the same. The storage 508 may be used to store various types of content described herein. Nonvolatile memory may also be used (e.g., to launch a boot-up routine and other instructions).

The control circuitry 504 may include audio generating circuitry and tuning circuitry, such as one or more analog tuners, audio generation circuitry, filters or any other suitable tuning or audio circuits or combinations of such circuits. The control circuitry 504 may also include scaler circuitry for upconverting and down converting content into the preferred output format of the user equipment device 500. The control circuitry 504 may also include digital-to-analog converter circuitry and analog-to-digital converter circuitry for converting between digital and analog signals. The tuning and encoding circuitry may be used by the user equipment device 800 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 508 is provided as a separate device from the user equipment device 500, the tuning and encoding circuitry (including multiple tuners) may be associated with the storage 508.

The user may utter instructions to the control circuitry 504, which are received by the microphone 516. The microphone 516 may be any microphone (or microphones) capable of detecting human speech. The microphone 516 is connected to the processing circuitry 506 to transmit detected voice commands and other speech thereto for processing. In some embodiments, voice assistants (e.g., Siri, Alexa, Google Home and similar such voice assistants) receive and process the voice commands and other speech.

The user equipment device 500 may optionally include an interface 510. The interface 810 may be any suitable user interface, such as a remote control, mouse, trackball, keypad, keyboard, touch screen, touchpad, stylus input, joystick, or other user input interfaces. A display 512 may be provided as a stand-alone device or integrated with other elements of the user equipment device 500. For example, the display 512 may be a touchscreen or touch-sensitive display. In such circumstances, the interface 510 may be integrated with or combined with the microphone 516. When the interface 510 is configured with a screen, such a screen may be one or more of a monitor, a television, a liquid crystal display (“LCD”) for a mobile device, active matrix display, cathode ray tube display, light-emitting diode display, organic light-emitting diode display, quantum dot display, or any other suitable equipment for displaying visual images. In some embodiments, the interface 810 may be HDTV-capable. In some embodiments, the display 512 may be a 3D display. A speaker 514 may be controlled by the control circuitry 504. The speaker (or speakers) 514 may be provided as integrated with other elements of user equipment device 500 or may be a stand-alone unit. In some embodiments, the display 512 may be output through speaker 514.

In some embodiments, the user equipment device 500 may optionally include a sensor 518. Although only one sensor 518 is shown, any number of sensors may be used. In some embodiments, the sensor 518 is a camera, depth sensors, Lidar sensor, and/or any similar such sensor.

The user equipment device 500 of FIG. 5 can be implemented in system 400 of FIG. 4 as user equipment device 402 and/or in system 300 of FIG. 3 as user equipment device 316, but any other type of user equipment suitable for providing customizes sports media may be used. For example, gambling machines, user equipment devices such as television equipment, computer equipment, wireless user communication devices, or similar such devices may be used. User equipment devices may be part of a network of devices. Various network configurations of devices may be implemented and are discussed in more detail below.

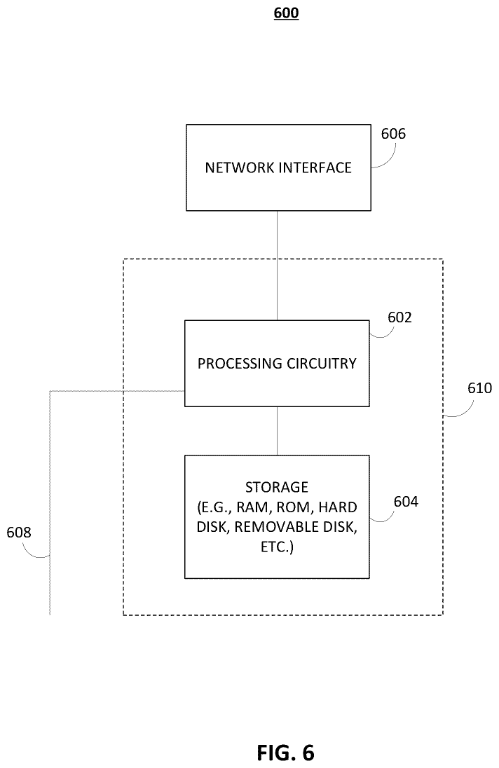

FIG. 6 shows an illustrative block diagram of a server system 600, in accordance with some embodiments of the disclosure. Server system 600 may include one or more computer systems (e.g., computing devices), such as a desktop computer, a laptop computer, and a tablet computer. In some embodiments, the server system 600 is a data server that hosts one or more databases (e.g., databases of images or videos, databases of historical sports data, etc.), models, or modules or may provide various executable applications or modules. In practice, and as recognized by those of ordinary skill in the art, items shown separately could be combined and some items could be separated. In some embodiments, not all shown items must be included in server system 600. In some embodiments, server system 600 may comprise additional items.

The server system 600 can include processing circuitry 602 that includes one or more processing units (processors or cores), storage 604, one or more network or other communications network interfaces 606, and one or more I/O paths 608. I/O paths 608 may use communication buses for interconnecting the described components. I/O paths 608 can include circuitry (sometimes called a chipset) that interconnects and controls communications between system components. Server system 600 may receive content and data via I/O paths 608. The I/O path 608 may provide data to control circuitry 610, which includes processing circuitry 602 and a storage 604. The control circuitry 610 may be used to send and receive commands, requests, and other suitable data using the I/O path 608. The I/O path 608 may connect the control circuitry 610 (and specifically the processing circuitry 602) to one or more communications paths. I/O functions may be provided by one or more of these communications paths but are shown as a single path in FIG. 6 to avoid overcomplicating the drawing.

The control circuitry 610 may be based on any suitable processing circuitry such as the processing circuitry 602. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

Memory may be an electronic storage device provided as the storage 604 that is part of the control circuitry 610. Storage 604 may include random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same.

In some embodiments, storage 604 or the computer-readable storage medium of the storage 604 stores an operating system, which includes procedures for handling various basic system services and for performing hardware dependent tasks. In some embodiments, storage 604 or the computer-readable storage medium of the storage 604 stores a communications module, which is used for connecting the server system 600 to other computers and devices via the one or more communication network interfaces 606 (wired or wireless), such as the internet, other wide area networks, local area networks, metropolitan area networks, and so on. In some embodiments, storage 604 or the computer-readable storage medium of the storage 604 stores a web browser (or other application capable of displaying web pages), which enables a user to communicate over a network with remote computers or devices. In some embodiments, storage 604 or the computer-readable storage medium of the storage 604 stores a database for historical sports data, historical sports media, augmentation data, 2D mapping data, 3D mapping data, virtual object data, user information data, encryption data, and/or similar such information.

In some embodiments, executable modules, applications, or sets of procedures may be stored in one or more of the previously mentioned memory devices and corresponds to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 604 stores a subset of the modules and data structures identified above. In some embodiments, the storage 604 may store additional modules or data structures not described above.

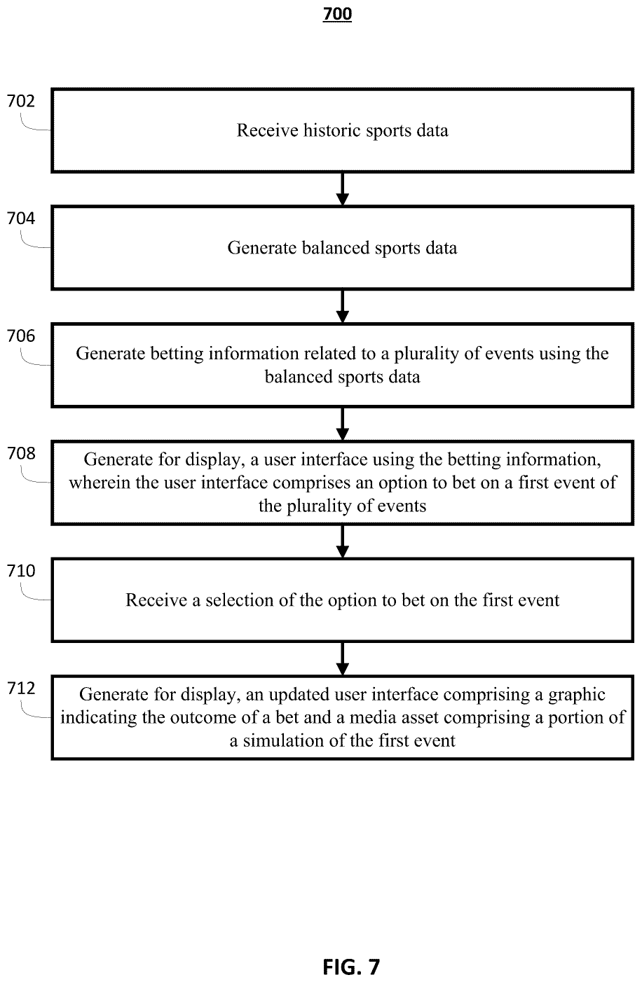

FIG. 7 is an illustrative flowchart of a process 700 for generating customized sports media assets using historical sport outcomes, in accordance with some embodiments of the disclosure. Process 700, and any of the following processes, may be executed by control circuitry 504 on a user equipment device 500 and/or control circuitry 610 on a server 600. In some embodiments, control circuitry may be part of a remote server separated from the user equipment device 500 by way of a communications network or distributed over a combination of both. In some embodiments, instructions for executing process 700 may be encoded onto a non-transitory storage medium (e.g., the storage 508, the storage 604) as a set of instructions to be decoded and executed by processing circuitry (e.g., the processing circuitry 506, the processing circuitry 602). Processing circuitry may, in turn, provide instructions to other sub-circuits contained within control circuitry, such as the encoding, decoding, encrypting, decrypting, scaling, analog/digital conversion circuitry, and the like. It should be noted that any of the processes, or any step thereof, could be performed on, or provided by, any of the devices described in FIGS. 1-6. Although the processes are illustrated and described as a sequence of steps, it is contemplated that various embodiments of the processes may be performed in any order or combination and need not include all the illustrated steps.

At 702, control circuitry receives historical sports data. In some embodiments, the historical sports data may comprise statistics, scouting reports, ratings, and attributes related to sports teams and/or individual players. The historical sports data may also comprise information related to a team's records, gameplan or play calling tendencies, play-by-play game summaries, roster and group playing time details, etc., and/or for individual player's detailed game statistics, and information on various attributes, such as speed, strength, height, weight, wingspan, health/injury history, etc. In some embodiments, the historical sports data may also comprise historical media (e.g., audio/video of historical games, promotional material related to historical games, images related to historical games, etc.).

At 704, control circuitry generates balanced sports data. In some embodiments, the control circuitry generates the balanced sports data by modifying the received historical sports data in response to results of a plurality of simulated games. For example, the control circuitry may generate the results by simulating a plurality of games using the historical sports data. The control circuitry may then compare the results to historical outcomes. If the difference between the results and the historical outcomes is greater than a threshold, then the control circuitry may modify the historical sports data. The control circuitry may repeat this process until the difference between a plurality of results, generated using the modified historical sports data, and the historical outcomes are within the threshold.

In some embodiments, the control circuitry selects which portions of the historical sports data are more deterministic of a target result and creates data structures to link particular sets of the portions of the historical sports data with the target result. For example, the simulated record for the Green Bay Packers may be less determined by the individual weight, height, speed of players on the Green Bay Packers and may be more determined based on the health/availability of players and their game play statistics (e.g., rushing yard average, completion percentage, receiving touchdowns, turnover ratio, etc.). However, the simulated outcome of Green Bay Packers scoring a touchdown from the 5-yard-line may be more influenced by the individual weight, height, speed of players on the Green Bay Packers. Storing correlations between portions of historical sports data and sports outcomes allow for more efficient and reliable creation of hypothetical on-demand betting scenarios based on user selection.

At 706, control circuitry generates betting information related to a plurality of events using the balanced sports data. In some embodiments, the control circuitry generates the betting information by first identifying the plurality of events. For example, the control circuitry may simulate events using the modified sports data and then generate percentages associated with the events. The control circuitry may select the plurality of events based on the percentages associated with each event of the plurality of events. For example, the control circuitry may select the plurality of events if the percentages associated with each event of the plurality of events are within a first range (e.g., between 30% and 70%). In another example, the control circuitry may select the plurality of events if the percentages associated with each event of the plurality of events are above a second threshold (e.g., above 15%). In another example, the control circuitry may select the plurality of events if the percentages associated with each event of the plurality of events are below a third threshold (e.g., below 65%). In some embodiments, the plurality of events are selected based at least in part on one or more outcomes associated with the plurality of events. For example, the plurality of events may be selected if one or more outcomes associated with the plurality of events are objective, measurable, and/or quantifiable (e.g., converting a first down, kicking a field goal, winning a game, etc.). The betting information may include the plurality of events, metadata related to the plurality of events, media content related to the plurality of events, and/or similar such information. In some embodiments, the metadata related to the plurality of events includes the percentages associated with each event of the plurality of events, historical sports data related to the plurality of events, modified historical sports data, and/or similar such information.

In some embodiments, the control circuitry generates betting lines based on the percentages and/or one or more random number generators (RNG). For example, a first event of the plurality of events may have a first percentage (40.567%) of success. The RNG may generate random numbers between a range (e.g., 1 and 100,000). The control circuitry may associate a first portion of numbers (e.g., numbers 1 through 40,567) with a successful result and a second portion of numbers (e.g., numbers 40, 568 through 100,000) with an unsuccessful result. In some embodiments, the control circuitry further adjusts the numbers to account for a house edge. For example, the first event of the plurality of events may have the first percentage (40.567%) of success. The RNG may generate random numbers between a range (e.g., 1 and 100,000). The control circuitry may associate a first portion of numbers (e.g., numbers 1 through 30,000) with a successful result and a second portion of numbers (e.g., numbers 30,001 through 100,000) with an unsuccessful result. In some embodiments, the control circuitry may adjust one or more percentages to account for a house edge. For example, the first event of the plurality of events may have a first percentage (40.567%) of success. The control circuitry may round the first percentage up or down to account for a house edge. For example, the control circuitry may round the first percentage (40.567%) down to a second percentage (e.g., 38%) to account for the house edge.

At 708, control circuitry generates for display, a user interface using the betting information, wherein the user interface comprises an option to bet on a first event of the plurality of events. For example, a first event may relate to a touchdown opportunity for the Dallas Cowboys. The option may correspond to a bet that the Dallas Cowboys will score a touchdown. In some embodiments, the user interface also comprises a second option related to the first event. For example, the second option may correspond to a bet that the Dallas Cowboys will not score a touchdown. In some embodiments, the user interface also displays the percentages related to the one or more options. For example, the user interface may display that the first option is associated with a 40% chance of success and the second option is associated with a 60% chance of success. In some embodiments, the user interface also displays an event description related to the first event. In some embodiments, the user interface also displays a betting amount where a user can input a value corresponding to the bet amount.

At 710, control circuitry receives a selection of the option to bet on the first event. In some embodiments, the control circuitry receives the selection via a user interface. For example, a display associated with the control circuitry may be a touch screen and a user may select the first option using the touch screen. In another example, a user may interact with a display associated with the control circuitry using a remote control, mouse, trackball, keypad, keyboard, touchpad, stylus input, joystick, or other user input interfaces.

At 712, control circuitry generates for display, an updated user interface comprising a graphic indicating the outcome of a bet and a media asset comprising a portion of a simulation of the first event. In some embodiments, the graphic corresponds to the option selected by the user and/or the outcome of a simulated event. For example, the control circuitry may determine the outcome of the first event and then compare the outcome of the first event to the option selected by the user. In some embodiments, if the control circuitry determines that the user won the bet, then the control circuitry may display a graphic indicating that the bet was successful. In some embodiments, if the control circuitry determines that the user lost the bet, then the control circuitry may display a graphic indicating that the bet was unsuccessful. In some embodiments, the graphic comprises text, video, audio, animation, and/or similar such content.

In some embodiments, the media asset corresponds to the outcome of the simulated event. For example, if the simulated event results in the Dallas Cowboys scoring a touchdown, then the media asset may depict the Dallas Cowboys scoring the touchdown. In another example, if the simulated event does not result in the Dallas Cowboys scoring a touchdown, then the media asset may depict the Dallas Cowboys not scoring the touchdown. In some embodiments, the control circuitry has access to a plurality of media assets corresponding to the plurality of events and the control circuitry selects the media asset based on the outcome of the simulated event. In some embodiments, each media asset of the plurality of media assets comprises metadata indicating that media assets relate to one or more events (e.g., first event associated with whether the Dallas Cowboys will score a touchdown). For example, a first media asset (e.g., depicting the Dallas Cowboys scoring the touchdown) may have metadata indicating that the first media asset is related to a first event (e.g., whether the Dallas Cowboys will score a touchdown) and a second media asset (depicting the Dallas Cowboys not scoring the touchdown) may have metadata indicting that the second medias asset is related to the first event.

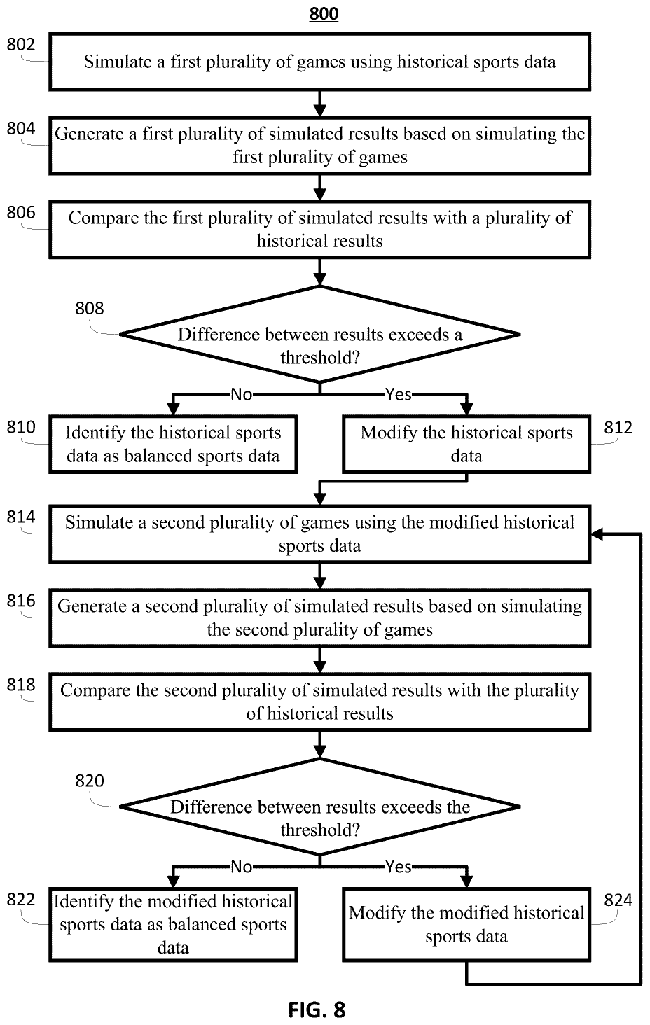

FIG. 8 is an illustrative flowchart of a process 800 for generating balanced sports data, in accordance with some embodiments of this disclosure.

At 802, control circuitry simulates a first plurality of games using historical sports data. For example, the control circuitry may simulate the entire 1993 National Football League season using the historical sports data.

At 804, control circuitry generates a first plurality of simulated results based on simulating the first plurality of games. For example, the control circuitry may determine the simulated records for each football team after simulating the entire 1993 National Football League season using the historical sports data.

At 806, control circuitry compares the first plurality of simulated results with a plurality of historical results. In some embodiments, the control circuitry receives historical results from one or more databases. In some embodiments, the historical sports data comprises the historical results. The control circuitry may compare one or more simulated results with one or more historical results. For example, the control circuitry may compare the Green Bay Packer's simulated record of 5 wins and 11 losses and the Green Bay Packer's historical record of 9 wins and 7 losses.

At 808, control circuitry determines whether a difference between the first plurality of simulated results and the plurality of historical results exceeds a threshold. In some embodiments, the threshold corresponds to a discrepancy between one or more simulated results and one or more historical results. If the control circuitry determines that the difference does not exceed the threshold, then the process 800 continues to step 810. If the control circuitry determines that the difference does exceed a threshold, then the process 800 continues to step 812.

At 810, control circuitry identifies the historical sports data as balanced sports data. In some embodiments, the balanced sports data is then used to generate betting information related to a plurality of events (e.g., step 706).

At 812, control circuitry modifies the historical sports data. Modifying the historical sports data may comprise increasing and/or decreasing one or more portions of the historical sports data based on the discrepancy between one or more simulated results and one or more historical results. In some embodiments, increasing one or more portions of the historical sports data includes increasing one or more values associated with the historical sports data. For example, the control circuitry may increase one or more values associated with the offense, defense, special teams, quarterback, running back, etc. associated with the Green Bay Packers. In some embodiments, decreasing one or more portions of the historical sports data includes decreasing one or more values associated with the historical sports data. For example, the control circuitry may decrease one or more values associated with the offense, defense, special teams, quarterback, running back, etc. associated with the Green Bay Packers.

At 814, control circuitry simulates a second plurality of games using the modified sports data. For example, the control circuitry may simulate the entire 1993 National Football League season again using the modified historical sports data.

At 816, control circuitry generates a second plurality of simulated results based on simulating the second plurality of games. For example, the control circuitry may determine updated simulated records for each football team after simulating the entire 1993 National Football League season again, using the modified historical sports data.

At 818, control circuitry compares the second plurality of simulated results with the plurality of historical results. The control circuitry may compare one or more simulated result of the second plurality of simulated results with one or more historical results. For example, the control circuitry may compare the Green Bay Packer's updated simulated record of 8 wins and 6 losses and the Green Bay Packer's historical record of 9 wins and 7 losses.

At 820, control circuitry determines whether a difference between the second plurality of simulated results and the plurality of historical results exceeds the threshold. If the control circuitry determines that the difference does not exceed the threshold, then the process 800 continues to step 822. If the control circuitry determines that the difference does exceed the threshold, then the process 800 continues to step 824.

At 822, control circuitry identifies the modified historical sports data as balanced sports data. In some embodiments, the balanced sports data is then used to generate betting information related to a plurality of events (e.g., step 706).

At 824, control circuitry modifies the modified historical sports data. Modifying the modified historical sports data may comprise increasing and/or decreasing one or more portions of the modified historical sports data based on the discrepancy between one or more simulated results of the second plurality of simulated results and one or more historical results. In some embodiments, increasing one or more portions of the modified historical sports data includes increasing one or more values associated with the modified historical sports data. In some embodiments, decreasing one or more portions of the modified historical sports data includes decreasing one or more values associated with the historical sports data.

In some embodiments, the control circuitry repeats steps 814-824 until the simulated results are within the threshold discrepancy of the historical results. In some embodiments, the control circuitry selects which portions of the historical sports data are more deterministic of a target result and creates data structures to link particular sets of the portions of the historical sports data with the target result. For example, the simulated record for the Green Bay Packers may be less determined by the individual weight, height, speed of players on the Green Bay Packers and may be more determined based on the health/availability of players and their game play statistics (e.g., rushing yard average, completion percentage, receiving touchdowns, turnover ratio, etc.). However, the simulated outcome of Green Bay Packers scoring a touchdown from the 5-yard-line may be more determined be more determined by the individual weight, height, speed of players on the Green Bay Packers. In another example, the chances of a particular player successfully sacking the quarterback may be more determined by the weight of the particular player, height of the particular player, speed of the particular player, years of experience of the particular player, weight of opposing player, height of opposing player, speed of opposing player, years of experience of the opposing player, defensive scheme of the opposing team, and may be less determined by the rushing yard average and completion percentage of the Green Bay Packers.

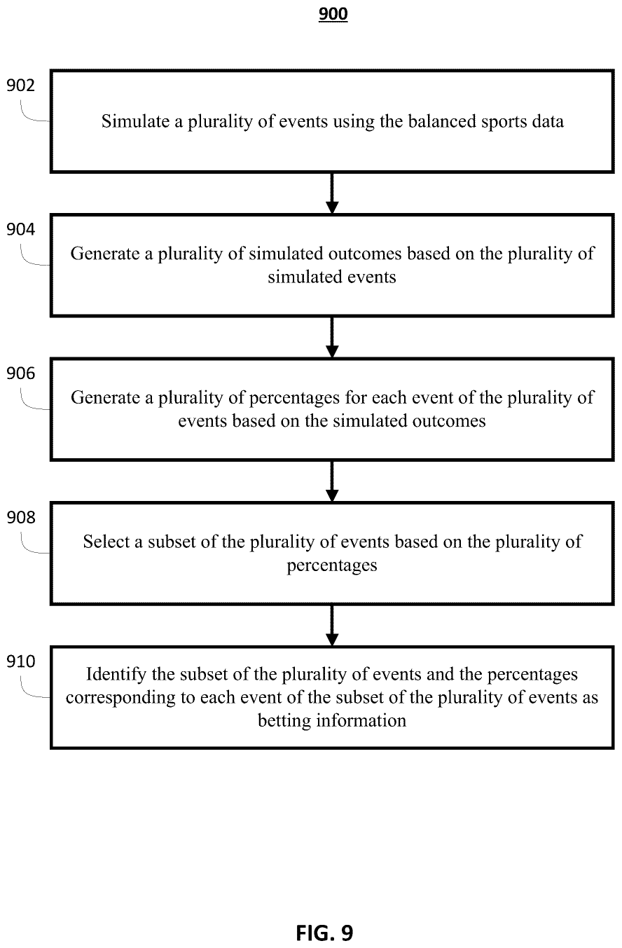

FIG. 9 is an illustrative flowchart of a process 900 for generating betting information, in accordance with some embodiments of this disclosure.

At 902, control circuitry simulates a plurality of events using balanced sports data. In some embodiments, the plurality of events correspond to betting scenarios (e.g., a team victory, a team loss, a team scoring a point, team being successful/unsuccessful on a play, a player scoring a point, a player being successful/unsuccessful on a play, and/or similar such events).

At 904, control circuitry generates a plurality of simulated outcomes based on the plurality of simulated events.

At 906, control circuitry generates a plurality of percentages for each event of the plurality of events based on the simulated outcomes. In some embodiments, the control circuitry generates the plurality of percentages by simulating each event of the plurality of events multiple times (e.g., 10 times, 100 times, 1,000, times, 10,000 times etc.). For example, the control circuitry may use the balanced sports data to simulate a first event corresponding to the Dallas Cowboys playing the Green Bay Packers. The control circuitry may simulate the first event one thousand times and determine a first percentage (60%) corresponding to how many times the Dallas Cowboys beat the Green Bay Packers in the one thousand simulations.

At 908, control circuitry selects a subset of the plurality of events based on the plurality of percentages. In some embodiments, the control circuitry selects the subset of the plurality of events based on the percentages associated with each event of the subset of the plurality of events. For example, the first event associated with the Dallas Cowboys playing the Green Bay Packers may be selected because the first percentage corresponding to how many times the Dallas Cowboys beat the Green Bay Packers is 60%. In some embodiments, the control circuitry selects the subset of the plurality of events if the percentages associated with each event of the subset of the plurality of events are within a first range (e.g., between 30% and 70%). In some embodiments, the control circuitry selects the subset of the plurality of events if the percentages associated with each event of the subset of the plurality of events are above a second threshold (e.g., above 15%). In some embodiments, the control circuitry selects the subset of the plurality of events if the percentages associated with each event of the subset of the plurality of events are below a third threshold (e.g., below 65%).

At 910, control circuitry identifies the subset of the plurality of events and the percentages corresponding to each event of the subset of the plurality of events as betting information. In some embodiments, the betting information comprises the subset of the plurality of events, metadata related to the subset of the plurality of events, media content related to the subset of the plurality of events, and/or similar such information. In some embodiments, the metadata related to the subset of the plurality of events includes the percentages associated with each event of the subset of events, historical sports data related to the subset of the plurality of events, modified historical sports data, and/or similar such information.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The invention claimed is:

1. A method comprising:
receiving, from at least one database, historical sports data related to a first sport;
generating, by a simulation engine, balanced sports data by:
simulating a first plurality of games using the historical sports data;
generating a first plurality of simulated results based on simulating the first plurality of games;
comparing the first plurality of simulated results with a plurality of historical results;
determining that a first difference between the first plurality of simulated results and the plurality of historical results exceeds a threshold;
in response to determining that the first difference between the first plurality of simulated results and the plurality of historical results exceeds the threshold, modifying the historical sports data to generate modified historical sports data;
simulating a second plurality of games using the modified historical sports data;
generating a second plurality of simulated results based on simulating the second plurality of games;
comparing the second plurality of simulated results with the plurality of historical results;
determining that a second difference between the second plurality of simulated results and the plurality of historical results does not exceed the threshold; and
in response to determining that the second difference between the second plurality of simulated results and the plurality of historical results does not exceed the threshold, identifying the modified historical sports data as balanced sports data;
generating, by a scenario engine, betting information comprising a plurality of odds and a plurality of selected events by:
simulating a plurality of events using the balanced sports data to determine a plurality of simulated outcomes;
generating a plurality of percentages for each event of the plurality of events based on the plurality of simulated outcomes;
selecting a subset of the plurality of events based on the plurality of percentages, wherein:
each event of the subset of the plurality of events corresponds to at least one percentage of a subset of the plurality of percentages; and
the subset of the plurality of events are selected based on each percentage the subset of the plurality of percentages being below a desired percentage; and
identifying the subset of the plurality of events and the percentages corresponding to each event of the subset of the plurality of events as betting information;
generating for display, by a first device, a user interface using the betting information, wherein the user interface comprises an option to bet on a first event of the subset of the plurality of events;
receiving, by the first device, a selection by a user of the option to bet on the first event of the subset of the plurality of events; and
in response to receiving the selection by the user, generating for display, by the first device, an updated user interface comprising:
a graphic indicating that a bet was successful based on the option selected; and
a first media asset comprising a portion of a simulation of the first event.

2. The method of claim 1, further comprising:
receiving, by the first device, a profile associated with the user, wherein the profile comprises at least one preference related to the user; and
recommending, by the first device, the first event to the user based on a first preference of the at least one preference related to the user.

3. The method of claim 1, further comprising:
generating, by a media asset generator, a plurality of media assets, wherein one or more media assets of the plurality of media assets corresponds to the first event; and
transmitting, by the media asset generator, the plurality of media assets to the first device.

4. The method of claim 3, wherein at least one media asset of the plurality of media assets is generated using one or more historical media assets.

5. The method of claim 3, further comprising:
determining, by the first device, an outcome of the first event, wherein the outcome is based at least in part on the betting information; and
selecting, by the first device, the first media asset from the plurality of media assets based at least in part on the outcome of the first event.

6. The method of claim 5, further comprising selecting, by the first device, the graphic based at least in part on the outcome of the first event.

7. The method of claim 1, wherein the first media asset comprises video data.

8. The method of claim 1, wherein the first media asset comprises audio data.

9. The method of claim 1, wherein a first server comprises the simulation engine and the scenario engine.

10. The method of claim 1, wherein a first server comprises the simulation engine and a second server comprise the scenario engine.

11. An apparatus, comprising:
control circuitry; and
at least one memory including computer program code for one or more programs, the at least one memory and the computer program code configured to, with the control circuitry, cause the apparatus to perform at least the following:
receive, from at least one database, historical sports data related to a first sport;
generate balanced sports data wherein the apparatus is further caused, when generating the balanced sports data, to:
simulate a first plurality of games using the historical sports data;
generate a first plurality of simulated results based on simulating the first plurality of games;
compare the first plurality of simulated results with a plurality of historical results;
determine that a first difference between the first plurality of simulated results and the plurality of historical results exceeds a threshold;
in response to determining that the first difference between the first plurality of simulated results and the plurality of historical results exceeds the threshold, modify the historical sports data to generate modified historical sports data;
simulate a second plurality of games using the modified historical sports data;
generate a second plurality of simulated results based on simulating the second plurality of games;
compare the second plurality of simulated results with the plurality of historical results;
determine that a second difference between the second plurality of simulated results and the plurality of historical results does not exceed the threshold; and
in response to determining that the second difference between the second plurality of simulated results and the plurality of historical results does not exceed the threshold, identify the modified historical sports data as balanced sports data;
generate betting information comprising a plurality of odds and a plurality of selected events, wherein the apparatus is further caused, when generating the betting information, to:
simulate a plurality of events using the balanced sports data to determine a plurality of simulated outcomes;
generate a plurality of percentages for each event of the plurality of events based on the plurality of simulated outcomes;
select a subset of the plurality of events based on the plurality of percentages, wherein:
each event of the subset of the plurality of events corresponds to at least one percentage of a subset of the plurality of percentages; and
the subset of the plurality of events are selected based on each percentage the subset of the plurality of percentages being below a desired percentage; and
identify the subset of the plurality of events and the percentages corresponding to each event of the subset of the plurality of events as betting information;
generate for display a user interface using the betting information, wherein the user interface comprises an option to bet on a first event of the subset of the plurality of events;
receive a selection by a user of the option to bet on the first event of the subset of the plurality of events; and
in response to receiving the selection by the user, generate for display an updated user interface comprising:
a graphic indicating that a bet was successful based on the option selected; and
a first media asset comprising a portion of a simulation of the first event.

12. The apparatus of claim 11, wherein the apparatus is further caused to:
receive a profile associated with the user, wherein the profile comprises at least one preference related to the user; and
recommend the first event to the user based on a first preference of the at least one preference related to the user.

13. The apparatus of claim 11, wherein the apparatus is further caused to:
generate a plurality of media assets, wherein one or more media assets of the plurality of media assets corresponds to the first event; and
transmit the plurality of media assets to a first device.

14. The apparatus of claim 13, wherein at least one media asset of the plurality of media assets is generated using one or more historical media assets.

15. The apparatus of claim 13, wherein the apparatus is further caused to:
determine an outcome of the first event, wherein the outcome is based at least in part on the betting information; and
select the first media asset from the plurality of media assets based at least in part on the outcome of the first event.

16. The apparatus of claim 15, wherein the apparatus is further caused to select the graphic based at least in part on the outcome of the first event.

17. The apparatus of claim 11, wherein the first media asset comprises video data.

18. The apparatus of claim 11, wherein the first media asset comprises audio data.

19. The apparatus of claim 11, wherein the apparatus is a server.

20. (canceled)

21. A non-transitory computer-readable medium having instructions encoded thereon that, when executed by control circuitry, cause the control circuitry to:
receive, from at least one database, historical sports data related to a first sport;
generate balanced sports data wherein the control circuitry is further caused, when generating the balanced sports data, to:
simulate a first plurality of games using the historical sports data;
generate a first plurality of simulated results based on simulating the first plurality of games;
compare the first plurality of simulated results with a plurality of historical results;
determine that a first difference between the first plurality of simulated results and the plurality of historical results exceeds a threshold;
in response to determining that the first difference between the first plurality of simulated results and the plurality of historical results exceeds the threshold, modify the historical sports data to generate modified historical sports data;
simulate a second plurality of games using the modified historical sports data;
generate a second plurality of simulated results based on simulating the second plurality of games;
compare the second plurality of simulated results with the plurality of historical results;
determine that a second difference between the second plurality of simulated results and the plurality of historical results does not exceed the threshold; and
in response to determining that the second difference between the second plurality of simulated results and the plurality of historical results does not exceed the threshold, identify the modified historical sports data as balanced sports data;
generate betting information comprising a plurality of odds and a plurality of selected events, wherein the control circuitry is further caused, when generating the betting information, to:
simulate a plurality of events using the balanced sports data to determine a plurality of simulated outcomes;
generate a plurality of percentages for each event of the plurality of events based on the plurality of simulated outcomes;
select a subset of the plurality of events based on the plurality of percentages, wherein:
each event of the subset of the plurality of events corresponds to at least one percentage of a subset of the plurality of percentages; and
the subset of the plurality of events are selected based on each percentage the subset of the plurality of percentages being below a desired percentage; and
identify the subset of the plurality of events and the percentages corresponding to each event of the subset of the plurality of events as betting information;
generate for display a user interface using the betting information, wherein the user interface comprises an option to bet on a first event of the subset of the plurality of events;
receive a selection by a user of the option to bet on the first event of the subset of the plurality of events; and
in response to receiving the selection by the user, generate for display an updated user interface comprising:
a graphic indicating that a bet was successful based on the option selected; and
a first media asset comprising a portion of a simulation of the first event.

22.-80. (canceled)
